(19) United States
(12) Patent Application Publication
(10) Pub. No.: US 2013/0293835 A1
(43) Pub. Date: Nov. 7, 2013

(54) ABRASION-RESISTANT FILM AND OPHTHALMIC LENS CONTAINING SAME

(71) Applicant: Essilor Internatinal (Compagnie Generale D'Optique), (US)

(72) Inventors: Charlotte SAINT-LU, Charenton Le Pont (FR); Annette CRETIER, Charenton Le Pont (FR); Christelle CLIPET, Charenton Le Pont (FR); Isabelle BONNET, Charenton Le Pont (FR)

(73) Assignee: Essilor Internatinal (Compagnie Generale D'Optique D'Optique), Charenton Le Pont (FR)

(21) Appl. No.: 13/874,623

(22) Filed: May 1, 2013

(30) Foreign Application Priority Data
May 4, 2012 (FR) 12 54121

(51) Int. Cl. G02C 7/02; B32B 27/08; B32B 7/12

(52) U.S. Cl. CPC G02C 7/022; B32B 7/12; B32B 27/08
USPC 351/159.57; 428/447; 428/337; 428/336; 156/60

(57) ABSTRACT

The present invention relates to an abrasion-resistant film comprising a transparent thermoplastic film and an abrasion-resistant composite coating, formed from a lower layer in contact with the thermoplastic film and an upper layer superimposed on the lower layer, said layers each containing a hydrolyzed epoxysilane and a hydrolyzed alkoxysilane, in different weight ratios. The present invention also relates to a multilayer optical article, preferably an ophthalmic lens, comprising a transparent substrate, an adhesive layer and the abovementioned abrasion-resistant film, and also to two processes for manufacturing such an article.

### RELATED APPLICATIONS AND INCORPORATION BY REFERENCE

This application claims priority to FR 12 54121, filed on May 4, 2012, the entirety of which is expressly incorporated by reference herein.

All documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to an abrasion-resistant film comprising a transparent thermoplastic film and an abrasion-resistant composite coating, formed from a lower layer in contact with the thermoplastic film and an upper layer superimposed on the lower layer, said layers each containing a hydrolyzed epoxysilane and a hydrolyzed alkoxysilane, in different weight ratios. It also relates to a multilayer optical article, preferably an ophthalmic lens, comprising a transparent substrate, an adhesive layer and the abovementioned abrasion-resistant film, and also to two processes for manufacturing such an article.

### BACKGROUND OF THE INVENTION

The development of ophthalmic articles manufactured from organic glass substrates, which are lighter than mineral glass substrates, has required the development of protective coatings which have good abrasion resistance, owing to the fact that organic glass is known to have a greater sensitivity to abrasion than conventional mineral glass. Organic glasses are therefore generally protected against abrasion by applying to them a coating composition based on silane hydrolysates which, after thermal or photochemical curing, in the presence of an aluminum-based catalyst, produces an abrasion-resistant lacquer which enables organic glasses to be handled and worn without damage.

Document WO 2008/062142 thus describes an abrasion-resistant lacquer, which moreover exhibits good scratch resistance, consisting of a lower layer, applied to an organic glass substrate, and of an upper layer applied to the lower layer. The lower and upper layers are each prepared from an epoxysilane, such as γ-glycidoxypropyltrimethoxysilane (GLYMO), and a silane which can be hydrolyzed, such as an alkoxysilane, in particular tetraethoxysilane (TEOS), but they differ from one another by virtue of the ratio, by weight, with respect to dry matter, of the epoxysilane to the alkoxysilane, which is higher in the lower layer, so as to obtain a hardness gradient between the two layers.

The prior art abrasion-resistant lacquers have, however, the drawback of undesirably reducing the impact resistance of organic ophthalmic lenses. One approach for solving this problem, suggested in document WO 2008/062142, has consisted in introducing, between the organic glass and the abrasion-resistant lacquer, a layer of elastomer primer, such as a polyurethane latex. This primer, deposited in the form of a liquid composition and then optionally crosslinked, absorbs not only the impacts received by the abrasion-resistant lacquer, but also provides good adhesion of the abrasion-resistant lacquer on the substrate. Its thickness is generally between 1 and approximately 20 μm. For very thin glasses which, in certain places, have thicknesses of about 1 mm only, the impact-resistant capacity of such bilayer systems (elastomer primer+abrasion-resistant lacquer) proves, however, to be insufficient. It is in fact impossible to increase the thickness of the elastomer primer beyond a certain limit without obtaining glasses which produce haze, unacceptable in the ophthalmic field.

Moreover, the addition of a layer of primer increases the complexity of the process for producing the optical article, in particular of that described in WO 2008/062142. Indeed, this process requires successively applying to the substrate the layer of primer, the lower layer and the upper layer, generally by dip coating or spin coating, each of the layers being cured at least partially by heating after application. In addition, frequent recourse to a surface treatment of the lower layer in order to improve the adhesion of the upper layer, which is generally carried out under vacuum. The preparation of the abrasion-resistant layers requires, moreover, the use of a strong acid, such as hydrochloric acid, in order to hydrolyze the mixture of silanes, and also of an organic solvent, such as methanol, which must be handled with care. It is understood that the implementation of all these steps requires not only time, but also the use of various equipment, such as tanks, incubators and coating equipment, that laboratories which manufacture ophthalmic lenses do not generally have, and also the handling of toxic chemical substances.

It would therefore be desirable to be able to have a means for conferring abrasion resistance and impact resistance on an optical article, which is simpler and less expensive than the prior art solutions.

### SUMMARY OF THE INVENTION

This need can be met by making available to laboratories which manufacture optical articles an abrasion-resistant film comprising a thermoplastic transparent film and an abrasion-resistant coating applied on one of the faces of the thermoplastic film. This abrasion-resistant film can be manufactured in the factory and supplied to the laboratory in a form precoated with adhesive so that said laboratory then only has to attach the film to at least one of the faces of the substrate. In addition, the anti-abrasive film according to the invention can be easily used in the manufacture of an optical article since it withstands well the steps of lamination of optical adhesives and sliding, and also thermoforming.

Thus, one embodiment of the present invention provided herein is an abrasion-resistant film comprising:
(a) a transparent film made of thermoplastic polymer, and
(b) an abrasion-resistant composite coating covering the transparent film, said coating comprising:
(i) a lower layer placed on the transparent film, obtained by hydrolysis then curing of a lower layer composition comprising at least one epoxysilane and at least one alkoxysilane, in a weight ratio (Rl), with respect to dry matter, of the epoxysilane to the alkoxysilane of at least 3, and
(ii) an upper layer placed on the lower layer, obtained by hydrolysis then curing of an upper layer composition comprising at least one epoxysilane and at least one alkoxysilane, in a weight ratio (Ru), with respect to dry matter, of the epoxysilane to the alkoxysilane of at most 2.

The invention also provides for an optical article, in particular an ophthalmic lens, comprising:
(a) a transparent substrate made of organic glass,
(b) an adhesive layer covering at least one of the faces of the transparent substrate, and
(c) an abrasion-resistant film as defined in any one of claims 1 to 11.

Additionally, the invention provides for a process for manufacturing an optical article, comprising the steps of:
A. providing a transparent organic substrate, preferably an ophthalmic lens substrate,
B. providing at least one abrasion-resistant film according to claim 11,
C. bringing the layer of adhesive of the abrasion-resistant film into contact with the organic substrate, and
D. applying a uniform pressure over the entire contact zone so as to cause the abrasion-resistant film to adhere on the organic substrate.

### DETAILED DESCRIPTION

Thermoplastic films are applied onto organic glass substrates with a view to improving their abrasion resistance. Such films are in particular sold by the company Nof under the trade name Realook®. However, these films exhibit only weak abrasion resistance, characterized by an ISTM Bayer value of between 1 and 2. In addition, it has been demonstrated that the application, on a bare thermoplastic film, of an abrasion-resistant lacquer as described in example 3 of application EP 0 614 957, comprising GLYMO as epoxysilane and DMDES as alkylalkoxysilane, makes it possible to obtain a slightly higher abrasion resistance, which is nevertheless below 3, in the ISTM Bayer test.

The instant invention provides for an abrasion-resistant film comprising a composite abrasion-resistant coating which makes it possible to achieve ISTM Bayer values of at least 7, generally between 8 and 10. In addition, these films confer good impact resistance and scratch resistance on the optical article containing them, without negatively affecting the optical properties of the glasses, even the thinnest. They also adhere perfectly to organic glasses.

Consequently, a subject of the present invention is an abrasion-resistant film comprising:
(a) a transparent film made of thermoplastic polymer, and
(b) an abrasion-resistant composite coating covering the transparent film, said coating comprising:
(i) a lower layer placed on the transparent film, obtained by hydrolysis then curing of a lower layer composition comprising at least one epoxysilane and at least one alkoxysilane, in a weight ratio (Rl), with respect to dry matter, of the epoxysilane to the alkoxysilane of at least 3,
(ii) an upper layer placed on the lower layer, obtained by hydrolysis then curing of an upper layer composition comprising at least one epoxysilane and at least one alkoxysilane, in a weight ratio (Ru), with respect to dry matter, of the epoxysilane to the alkoxysilane of at most 2.

A subject of the invention is also an optical article, in particular an ophthalmic lens, comprising:
(a) a transparent substrate made of organic glass,
(b) an adhesive layer covering at least one of the faces of the transparent substrate, and
(c) an abrasion-resistant film as previously defined.

A subject of the present invention is also two processes for manufacturing such an optical article. The two processes, described in detail below, differ from one another essentially in that, in one of the processes, the adhesive layer is first applied on one of the faces of the abrasion-resistant film, whereas in the second process, the adhesive layer is applied on the substrate. In the latter case, the substrate covered with the adhesive layer then receives the abrasion-resistant film.

More specifically, a subject of the present invention is a first process for manufacturing an optical article according to the invention, preferably an ophthalmic lens, comprising:
A. providing a transparent organic substrate, preferably an ophthalmic lens substrate,
B. providing at least one abrasion-resistant film according to the invention, containing a layer of adhesive applied on the face of the transparent film which is opposite that bearing the abrasion-resistant coating,
C. bringing the layer of adhesive of the abrasion-resistant film into contact with the organic substrate, and
D. applying a uniform pressure over the entire contact zone so as to cause the abrasion-resistant film to adhere on the organic substrate.

The abrasion-resistant film used in step D can be optionally thermoformed beforehand.

A subject of the present invention is also a second process for manufacturing an optical article according to the invention, preferably an ophthalmic lens, comprising:
a. providing a transparent organic substrate, preferably an ophthalmic lens substrate, covered on at least one of its faces with a layer of adhesive,
b. providing at least one abrasion-resistant film according to the invention,
c. bringing the face of the abrasion-resistant film bearing the transparent film into contact with the layer of adhesive, and
d. applying a uniform pressure over the entire contact zone so as to cause the abrasion-resistant film to adhere on the organic substrate.

The organic substrate of the optical article of the present invention can be any organic substrate commonly used in the optical field and in particular the ophthalmic field.

By way of examples, mention may be made of substrates made of polycarbonate, of polyamide, of polyimide, of polysulfone, of poly(ethylene terephthalate)/polycarbonate copolymers, of polyolefins, in particular of polynorbornene, of polyol allyl carbonate homopolymers and copolymers, in particular diethylene glycol bis(allyl carbonate) homopolymers and copolymers, of polymers and copolymers of alkyl (meth)acrylates or of aromatic (meth)acrylates which are polyethoxylated, in particular derived from bisphenol A, of thio(meth)acrylic polymers and copolymers, of poly(thio)urethane, of epoxy polymers and copolymers and of episulfide polymers and copolymers.

The organic substrate can be subjected, before application of or bringing into contact with the layer of adhesive, to a surface treatment generally intended to improve the adhesion, such as a physical treatment, for example by corona discharge, by vacuum plasma or by ion bombardment, or a chemical surface treatment, for example a hot sodium treatment with ultrasound.

The abrasion-resistant film, set out in the present invention via an adhesive layer on the substrate made of organic glass, consists:
of a layer formed from a transparent thermoplastic polymer, and
of an abrasion-resistant coating deposited on one of the faces of the thermoplastic layer.

In one embodiment of the invention, provided is an abrasion-resistant film comprising:
(a) a transparent film made of thermoplastic polymer, and
(b) an abrasion-resistant composite coating covering the transparent film, said coating comprising:
(i) a lower layer placed on the transparent film, obtained by hydrolysis then curing of a lower layer composition comprising at least one epoxysilane and at least one alkoxysilane, in a weight ratio (Rl), with respect to dry matter, of the epoxysilane to the alkoxysilane of at least 3,
(ii) an upper layer placed on the lower layer, obtained by hydrolysis then curing of an upper layer composition comprising at least one epoxysilane and at least one alkoxysilane, in a weight ratio (Ru), with respect to dry matter, of the epoxysilane to the alkoxysilane of at most 2.

In another embodiment of the present invention, provided is an abrasion-resistant film, characterized in that the thermoplastic polymer forming the transparent film is chosen from cellulose triacetate (CTA) and poly(ethylene terephthalate) (PET).

In another embodiment of the present invention, provided is an abrasion-resistant film, characterized in that the transparent film made of thermoplastic polymer has a thickness of between 50 μm and 150 μm, preferably between 60 μm and 100 μm.

In another embodiment of the present invention, provided is an abrasion-resistant film, characterized in that the abrasion-resistant coating has a thickness of between 1 and 15 μm, preferably between 2 and 10 μm, the thickness of the lower layer being greater than that of the upper layer.

In another embodiment of the present invention, provided is an abrasion-resistant film, characterized in that the epoxysilanes of the upper layer composition and of the lower layer composition are independently chosen from the epoxysilanes of formula (I):

RₙYₘSi(X)₄₋ₙ₋ₘ (I)

wherein:
R denotes a monovalent organic group bonded to the silicon via a carbon atom and containing at least one epoxy function,
X denotes a hydrolyzable group, preferably an —OR₁ group where R₁ denotes a linear or branched, preferably C₁-C₄, alkyl group, an alkoxyalkyl or acyloxy group, a halogen atom or an amino group optionally substituted with one or two alkyl or silane groups, preferably X denotes an alkoxy group,
Y denotes a monovalent organic group bonded to the silicon via a carbon atom and not containing an epoxy function, such as a saturated or unsaturated, C₁-C₁₀, and better still C₁-C₄, hydrocarbon-based group, in particular an alkyl group, and
n and m are integers such that: n=1 or 2 with n+m=1 or 2.

In another embodiment of the present invention, provided is an abrasion-resistant film, characterized in that the epoxysilanes of the upper layer composition and of the lower layer composition are independently chosen from the epoxysilanes of formula RSi(X)₃, such as γ-glycidoxypropyltriethoxysilane, γ-glycidoxypropyltrimethoxysilane, 2-(3,4-epoxycyclohexyl)ethyltrimethoxysilane and 2-(3,4-epoxycyclohexyl)ethyltriethoxysilane, preferably γ-glycidoxypropyltrimethoxysilane (GLYMO).

In another embodiment of the present invention, provided is an abrasion-resistant film, characterized in that the alkoxysilanes of the upper layer composition and of the lower layer composition are independently chosen from those of formula (II):

Si(OR′)₄ (II)

in which the R′ groups are identical to or different from one another and denote linear C₁-C₆ or branched C₃-C₆ alkyl groups.

In another embodiment of the present invention, provided is an abrasion-resistant film, characterized in that the alkoxysilanes of the upper layer composition and of the lower layer composition are independently chosen from tetraalkyl orthosilicates, such as tetraethoxysilane (or TEOS), tetramethoxysilane or TMOS), tetra(n-propoxy)silane, tetra(isopropoxy)silane, tetra(n-butoxy)silane, tetra(sec-butoxy)silane and tetra(t-butoxy)silane, preferably tetraethoxysilane (TEOS).

In another embodiment of the present invention, provided is an abrasion-resistant film, characterized in that Rl is at least equal to 3.5, preferably at least equal to 4 or even at least equal to 4.5.

In another embodiment of the present invention, provided is an abrasion-resistant film, characterized in that Ru is less than 1.5, preferably less than 1.

In another embodiment of the present invention, provided is an abrasion-resistant film, characterized in that it also contains a layer of adhesive applied on the face of the transparent film opposite that bearing the abrasion-resistant coating.

In another embodiment of the present invention, provided is an optical article, in particular ophthalmic lens, comprising:
(a) a transparent substrate made of organic glass,
(b) an adhesive layer covering at least one of the faces of the transparent substrate, and
(c) an abrasion-resistant film as defined in any one of claims 1 to 11.

In another embodiment of the present invention, provided is an optical article according, characterized in that it is an ophthalmic lens in which the two faces of the substrate are covered with an abrasion-resistant film.

In another embodiment of the present invention, provided is an optical article, characterized in that it has a minimum thickness at the center of less than 2 mm, preferably less than 1.5 mm, even more preferably less than 1.2 mm.

In another embodiment of the present invention, provided is a process for manufacturing an optical article, comprising:
A. providing a transparent organic substrate, preferably an ophthalmic lens substrate,
B. providing at least one abrasion-resistant film according to claim 11,
C. bringing the layer of adhesive of the abrasion-resistant film into contact with the organic substrate, and
D. applying a uniform pressure over the entire contact zone so as to cause the abrasion-resistant film to adhere on the organic substrate.

In another embodiment of the present invention, provided is a process for manufacturing, comprising:
a. providing a transparent organic substrate, preferably an ophthalmic lens substrate, covered on at least one of its faces with a layer of adhesive,
b. providing at least one abrasion-resistant film,
c. bringing the face of the abrasion-resistant film bearing the transparent film into contact with the layer of adhesive, and
d. applying a uniform pressure over the entire contact zone so as to cause the abrasion-resistant film to adhere on the organic substrate.

The thermoplastic polymer must be a transparent polymer, i.e. a polymer which has a haze of less than 0.5%, preferably between 0.2% and 0.3%, and a transmittance factor at least equal to 90%, preferably between 93% and 98% (these haze and transmittance factor measurements are carried out according to the ASTM D1003 standard on a Haze Guard instrument). Its glass transition temperature is higher than the temperature at which the optical article is used, which is most commonly ambient temperature. It is generally between 50° C. and 250° C., preferably between 70 and 200° C., as measured by dynamic mechanical analysis. At the temperature at which it is used, the thermoplastic polymer film is not therefore in the plastic state, but in the vitreous, rigid and brittle state.

Use will preferably be made, as transparent thermoplastic film for the implementation of the present invention, of a film made of poly(ethylene terephthalate) or PET, advantageously having a glass transition temperature (Tg), measured by DMA (dynamic mechanical analysis), of between 50° C. and 150° C., or a film of cellulose triacetate or CAT, having, for example, a Tg of between 100 and 180° C. The thickness of this film made of thermoplastic polymer is preferably between 50 μm and 150 μm, in particular between 60 μm and 100 μm.

This polymer film is coated on one of its faces with an abrasion-resistant coating consisting of an upper layer and of a lower layer, each of which contains an epoxysilane and an alkoxysilane which are hydrolyzed.

The epoxysilanes that can be used according to the invention advantageously correspond to formula (I):

RₙYₘSi(X)₄₋ₙ₋ₘ (I)

where R denotes a monovalent organic group bonded to the silicon via a carbon atom and containing at least one epoxy function, X denotes a □ydrolysable group, Y denotes a monovalent organic group bonded to the silicon via a carbon atom and not containing an epoxy function, and n and m are integers such that: n=1 or 2 with n+m=1 or 2.

The X groups can denote, independently of one another, —OR₁ groups where R₁ denotes a linear or branched, preferably C₁-C₄, alkyl group, an alkoxyalkyl or acyloxy group, a halogen atom or an amino group optionally substituted with one or two alkyl or silane groups. Preferably, X denotes an alkoxy group. After hydrolysis, the X groups give OH groups. The R group, for its part, preferably contains at least one epoxy function, preferably a single epoxy function such as an oxirane function. When it is present, the Y group can be a saturated or unsaturated, C₁-C₁₀, and better still C₁-C₄, hydrocarbon-based group, such as an alkyl group.

Among the epoxysilanes of formula (I), those of formula Rsi(X)₃ are preferred. Examples of such epoxysilanes are γ-glycidoxypropyltriethoxysilane, γ-glycidoxypropyltrimethoxysilane, 2-(3,4-epoxycyclohexyl)ethyltrimethoxysilane and 2-(3,4-epoxycyclohexyl)ethyltriethoxysilane. Use is preferably made of γ-glycidoxypropyltrimethoxysilane (GLYMO) in this invention.

For its part, the alkoxysilane used in the present invention preferably corresponds to formula (II):

Si(OR′)₄ (II)

in which the R′ groups are identical to or different from one another and denote linear C₁-C₆ or branched C₃-C₆ alkyl groups.

Examples of such alkoxysilanes are tetraalkyl orthosilicates such as tetraethoxysilane (or TEOS), tetramethoxysilane (or TMOS), tetra(n-propoxy)silane, tetra(isopropoxy)silane, tetra(n-butoxy)silane, tetra(sec-butoxy)silane and tetra(t-butoxy)silane, TEOS being preferred for use in this invention.

It is clearly understood that the epoxysilane of the upper layer may be identical to that of the lower layer or different from said epoxysilane. It is, moreover, possible to use mixtures of epoxysilanes in one of the layers or in both. Similarly, the alkoxysilane of the upper layer may be identical to that of the lower layer or different from said alkoxysilane. It is, moreover, possible to use mixtures of alkoxysilanes in one of the layers or in both.

The epoxysilane and alkoxysilane hydrolyzates used according to the invention are prepared conventionally, by adding an inorganic acid, such as hydrochloric acid or phosphoric acid, to a solution of these compounds in water and/or an organic solvent such as methanol.

The formulation of the upper and lower layers can contain, in addition to at least one epoxysilane, at least one alkoxysilane, a solvent and an inorganic acid, as described above, at least one condensation catalyst, such as a compound containing several carboxylic acid or carboxylic anhydride functions, preferably itaconic acid, or as a variant trimellitic acid or trimellitic anhydride. As a variant or in addition, this formulation can contain at least one curing catalyst, such as a compound based on aluminum, in particular aluminum acetylacetonate, dicyandiamide or mixtures thereof. Moreover, it is possible to include in the formulation at least one compound chosen from: a fluoro or silicone surfactant, an inorganic filler, a chelating agent, a UV-absorbing agent, and mixtures thereof.

As previously indicated, the upper and lower layers differ from one another in terms of the weight ratio of the epoxysilane to the alkoxysilane that they contain. Thus, in the lower layer, the weight ratio (Rl), with respect to dry matter, of the epoxysilane to the alkoxysilane is at least 3, preferably at least 3.5, or even at least 4 or at least equal to 4.5. In the upper layer, the weight ratio (Ru), with respect to dry matter, of the epoxysilane to the alkoxysilane is at most 2, preferably at most 1.5, or even at most 1.

The thickness of the abrasion-resistant coating constituted by the abovementioned two layers is similar to that of the known abrasion-resistant coatings and is generally between 1 and 15 μm, preferably between 2 and 10 μm, the thickness of the lower layer being greater than that of the upper layer.

In a first embodiment of the invention, the thermoplastic film receives, on its face opposite that bearing the abrasion-resistant coating, a thin layer of adhesive.

In a second embodiment, the layer of adhesive is applied on at least one of the substrate faces.

In any event, various families of adhesives can be used in the context of the invention. These adhesives preferably have an elastic modulus, or Young's modulus, lower than that of the substrate and lower than that of the thermoplastic film. In general, the adhesive has an elastic modulus at ambient temperature of between 10³ and 10⁷ Pa (Pascal). Among the adhesives which are particularly suitable for the invention, mention may in particular be made of pressure-sensitive adhesives (PSAs) and hotmelt adhesives (HMAs).

The term “PSA” is understood to mean a dry contact adhesive, generally of viscoelastic nature, which only requires a weak pressure to adhere on the contact surface. PSAs are characterized in that they do not require activation by water or a solvent or by heating in order to exert their adhesive nature permanently on a contact surface. Advantageously, the pressure-sensitive adhesive (PSA) used is chosen from the group formed by a polyacrylate-based compound, a block copolymer based on styrene and a mixture containing a natural rubber. More particularly, mention may be made, by way of examples and in a nonlimiting manner, of PSAs of general compositions based on polyacrylates, on polymethacrylates, on ethylenic copolymers such as ethylene/vinyl acetate, ethylene/ethyl acrylate and ethylene/ethyl methacrylate copolymers, PSAs based on synthetic rubber and elastomers containing silicones, polyurethanes, styrene-butadienes, polybutadienes, polyisoprenes, polypropylenes, polyisobutylenes, PSAs based on polymers comprising nitriles or acrylonitriles, PSAs based on polychloroprene, PSAs based on block copolymers comprising polystyrene, polyethylene, polypropylene, polyisoprene or polybutadiene blocks, and also blends of these polymers.

These PSAs can also contain one or more additives chosen in particular from tackifiers, plasticizers, binders, antioxidants, stabilizers, pigments, dyes, dispersants and diffusing agents. Preferentially, in the context of the invention, a PSA based on polyacrylate will be used. For the application envisaged in the present invention, it is important to select the PSA in such a way as not to undesirably reduce the transparency of the optical article obtained. The layer of PSA can of course have a cloudy appearance before application on the organic substrate, but this cloudiness must disappear after adhesive bonding. The peeling force (90° peeling test) can vary between 10 and 25 N/25 mm.

The PSAs available on the market and suitable for use as an adhesive in the present invention are PSAs of optical quality, also very widely used in the field of display screens. Mention may be made, by way of example, of the products sold by the company Nitto Denko, such as the PSA CS 9621, or else the adhesive 3M 8141, sold by the company 3M.

The layer of PSA can be applied on the film made of thermoplastic polymer before or after application of the abrasion-resistant coating, but is preferably applied after said coating. The PSA layer can optionally be protected by a weak-adhesion layer that will be detached by peeling directly before application of the layer of adhesive on the substrate.

It is also possible to use, in the context of the invention, a hotmelt adhesive. The term “hotmelt adhesive” encompasses conventional HMAs which can melt and harden a large number of times, but also reactive HMAs which are applied like conventional HMAs but crosslink and thus form permanent adhesive bonds that it is impossible to melt once again.

Hotmelt adhesives of optical quality are preferably adhesives based on polyurethanes which are in the form of aqueous dispersions of high-molecular-weight polyurethanes. The company Bayer sells two suitable hotmelt adhesives under the names Dispercoll® U 42 and KA-8758. The company Bond Polymers International LLC also proposes two hotmelt adhesives in the form of aqueous dispersions of polyurethanes under the references Bondthane® UD-104 and Bondthane® UD-108. These aqueous dispersions can be mixed, before application, with additives intended to modify their rheological, mechanical or optical properties. Thus, the addition of a colloidal silica will result in increased hardness and increased durability.

The hotmelt polymers can be chosen from polyolefins, polyamides, polyurethanes, poly(urethaneurea), poly(vinylpyrrolidone)s, polyesters, poly(esteramide)s, poly(oxazoline)s, and acrylic polymer-based systems. Polyolefins which are suitable as hotmelt adhesives are described, for example, in patent U.S. Pat. No. 5,128,388. Preference is in particular given to polyolefins chosen from elastomer block copolymers, such as those comprising blocks of polystyrene, of polybutadiene, of polyisoprene or blocks which are ethylene/butylene copolymers.

The thickness of the layer of adhesive is generally between 10 and 50 μm, preferably between 15 and 30 μm.

The abrasion-resistant film according to the invention can be manufactured in the following way.

In a first step, the thermoplastic film can be subjected to a surface treatment which is intended to facilitate the adhesion of the lower layer. It can in particular be a physical treatment, for example by corona discharge, by plasma or by ion bombardment, or a chemical surface treatment, for example a hot sodium treatment with ultrasound. In the case of a thermoplastic film made of PET, use is preferably made of a microwave-excited oxygen plasma treatment. In the case of a film made of CTA, chemical treatments are preferably used. It will be noted that it is not necessary to apply a layer of primer on the thermoplastic film, which simplifies the film manufacturing process, and therefore the optical article, according to the invention.

In a second step, the lower layer is applied on the thermoplastic film according to known processes, for example by spin coating, by dip coating, by bar coating or by spray coating, preferably by spin coating.

It is then prepolymerized. A lacquer film is thus obtained, which is then coated, after cooling, and preferably also by spin coating, with the upper layer. After polymerization, an abrasion-resistant film according to the invention is obtained.

When the thermoplastic film bears an adhesive layer on its face opposite that bearing the lower layer, this process can also comprise a step consisting in subjecting the thermoplastic film to a physical or chemical surface treatment, as previously described, before application of the adhesive. Where this film already bears the abrasion-resistant coating, it may be useful to protect the upper layer of this coating using a sacrificial film, in order to avoid damaging the coating during the surface treatment.

The transparent substrate made of organic glass and the abrasion-resistant film according to the invention are then adhesively bonded together. These adhesive bonding steps are preferably preceded by a step of thermoforming of the abrasion-resistant film, at a temperature below the glass transition temperature of the thermoplastic polymer. The objective of this thermoforming step is essentially to give the abrasion-resistant film a shape similar to that of the surface onto which it will be adhesively bonded, in order to avoid stresses, folds or damage to the abrasion-resistant film during the adhesive bonding step. The thermoforming temperature is preferably at least 10° C. below the glass transition temperature.

The thermoforming and the adhesive bonding of the abrasion-resistant film on the substrate made of organic glass can be carried out according to techniques known in the art. By way of examples of such processes, mention may be made of those described in detail in applications EP 2018262 and WO 2006/105999, both in the name of the applicant.

When the optical article is an ophthalmic lens and in particular a thin ophthalmic lens, the abrasion-resistant film is advantageously deposited on both faces of the organic substrate, i.e. on the rear face and the front face of the lens. It is preferred that the abrasion-resistant film be at least adhesively bonded on the convex face (generally the front face) of an ophthalmic lens.

As indicated in the introduction, the film according to the invention can be advantageously applied on very thin ophthalmic lenses, with a negative diopter, having very small thicknesses at the center. In one particularly preferred embodiment, the optical article of the present invention is consequently an ophthalmic lens having a minimum thickness at the center of less than 2 mm, preferably less than 1.5 mm, even more preferably less than 1.2 mm, this thickness encompassing both the organic substrate and the abrasion-resistant film(s) adhesively bonded thereto.

It is then possible to deposit an antireflective film on the optical article, on top of the upper layer. Antireflective coatings are well known and conventionally comprise a monolayer or multilayer stack of dielectric materials such as SiO, SiO₂, Al₂O₃, MgF₂, LiF, Si₃N₄, TiO₂, ZrO₂, Nb₂O₅, Y₂O₃, HfO₂, Sc₂O₃, Ta₂O₅, Pr₂O₃ and mixtures thereof. A multilayer stack comprising alternating inorganic dielectric layers with a high refractive index (RI>1.55) and with a low refractive index (RI<1.55) is preferably used, the latter advantageously comprising a mixture of SiO₂ and Al₂O₃.

The resulting optical article is characterized in particular:
by excellent abrasion resistance, corresponding to an ISTM Bayer value of at least 7, preferably between 8 and 10, this value being measured according to the ASTM F735-81 standard with the following modifications: 300 cycles are carried out instead of 200, and the abrasive powder is alumina ZF 152412 supplied by the company Ceramic Grains; and/or
by good scratch resistance, corresponding to a score of 1 to 3 in the steel wall test. This test consists in passing the steel wall back and forwards five times, in the direction of the fibers, on the face of an optical article according to the invention, by manually rubbing the surface with an amplitude of 4 to 5 cm, while applying a constant pressure on the steel wall (5 kg in the forward direction and 2.5 kg in the backward direction). The optical article is then wiped with a dry cloth, rinsed with alcohol and inspected visually in order to give it a score of 1 if no scratching is observed and 3 if the glass is quite scratched, a score of 5 corresponding to a glass which is very scratched; and/or
perfect adhesion, corresponding to a value of 0, while dry as after aging for 80 h, in the adhesion test (cross-hatch test) described in the ASTM D3359-93 standard; and/or
excellent impact resistance, measured according to the ANSI standard Z 80.1-1987.

The invention will now be described in greater detail by means of the following example which is given for illustration purposes only and is not intended to limit the scope of the invention, defined by the appended claims.

### EXAMPLES

### Organic Substrate

Organic glasses made of polycarbonate having a refractive index of 1.59 (Airwear® sold by the company Essilor), a diopter of −1.50 and a thickness at the center of 0.9 mm or of 1.1 mm are used. These glasses are subjected, before application of the abrasion-resistant films according to the invention, to a surface treatment by oxygen plasma under reduced pressure.

### Abrasion-Resistant Film

The following is used as transparent thermoplastic film:
a film made of cellulose triacetate (FT TD 80SL sold by the company Fuji) having a thickness of 80 μm and a glass transition temperature, determined by dynamic mechanical analysis (DMA), of 170° C., or
a film made of poly(ethylene terephthalate) (U34® sold by Toray Co.) having a thickness of 75 μm (glass transition temperature determined by DMA=119° C.).

The film made of PET is subjected to a microwave-excited oxygen plasma treatment, while the film made of CTA is dipped in a hot bath (at approximately 40° C.) of sodium hydroxide at 5% for 3 to 4 minutes, followed by rinses with water and drying. These films are then cut into a sheet of 15×22 cm.

After a period of 8 hours following the passing through sodium hydroxide for the film made of CTA, and within an hour following the plasma treatment for the PET, a lower layer composition, previously filtered and left to stand, is then deposited on these films, said composition consisting of:
GLYMO: 65.95%; TEOS: 14.40%; itaconic acid: 14.99%; dicyandiamide: 4.66%, the above percentages being given by weight of dry matter relative to the total weight of the dry matter of the layer (which does not comprise the surfactant, the hydrochloric acid and the solvent).

The ratio by weight of the epoxysilane (GLYMO) to the alkoxysilane (TEOS) of this layer is therefore equal to Rl=4.58.

This layer is applied by spin coating under the following conditions:
rotational speed during the application: 200 revolutions/minute,
movement of the arm from the center of the sample to the edge,
rotational speed after application: 900 to 1100 revolutions/minute for 20 seconds.

The thickness of the lower layer is fixed at 3 μm and controlled by SMR. The lower layer is then prepolymerized for 20 minutes at 85° C. in an incubator.

After cooling of the lacquer films, an upper layer composition having a thickness of 1 μm is deposited thereon by spin coating under the same conditions, said composition consisting of:
GLYMO: 48.07%; TEOS: 47.90%; dicyandiamide: 4.03%,

the above percentages being given by weight of dry matter relative to the total weight of the dry matter of the layer (which does not comprise the surfactant, the phosphoric acid and the solvent).

The ratio by weight of the epoxysilane (GLYMO) to the alkoxysilane (TEOS) of this layer is therefore equal to Ru=1.00.

The whole is then polymerized for 3 hours at 100° C. in an incubator.

Abrasion-resistant films according to the invention are thus obtained.

It is then possible to apply, on the opposite face of the resulting films, a layer of acrylic PSA (Nitto CS9621) with a thickness of approximately 25 μm.

The abrasion-resistant films are then thermoformed at a temperature of approximately 100° C. in order to give them the shape of the surface on which they will be adhesively bonded.

### Adhesive Bonding

The adhesive bonding of the abrasion-resistant films on the lenses made of organic glass is done by means of the process described in WO 2006/105999, by application of a uniform pressure of approximately 0.03 MPa via a deformable pad.

The resulting lenses are then subjected to machining using a National Optronics 6E edger and milled into the shape of a disk 50 mm in diameter.

Having thus described in detail preferred embodiments of the present invention, it is to be understood that the invention defined by the above embodiments is not to be limited to particular details set forth in the above description as many apparent variations thereof are possible without departing from the spirit or scope of the present invention.

1. An abrasion-resistant film comprising:
(a) a transparent film made of thermoplastic polymer, and
(b) an abrasion-resistant composite coating covering the transparent film, said coating comprising:
(i) a lower layer placed on the transparent film, obtained by hydrolysis then curing of a lower layer composition comprising at least one epoxysilane and at least one alkoxysilane, in a weight ratio (Rl), with respect to dry matter, of the epoxysilane to the alkoxysilane of at least 3,
(ii) an upper layer placed on the lower layer, obtained by hydrolysis then curing of an upper layer composition comprising at least one epoxysilane and at least one alkoxysilane, in a weight ratio (Ru), with respect to dry matter, of the epoxysilane to the alkoxysilane of at most 2.

2. The abrasion-resistant film according to claim 1, wherein the thermoplastic polymer forming the transparent film is chosen from cellulose triacetate (CTA) and poly(ethylene terephthalate) (PET).

3. The abrasion-resistant film according to claim 1, wherein the transparent film made of thermoplastic polymer has a thickness of between 50 μm and 150 μm, preferably between 60 μm and 100 μm.

4. The abrasion-resistant film according to claim 1, wherein the abrasion-resistant coating has a thickness of between 1 and 15 μm, preferably between 2 and 10 μm, the thickness of the lower layer being greater than that of the upper layer.

5. The abrasion-resistant film according to claim 1, wherein the epoxysilanes of the upper layer composition and of the lower layer composition are independently chosen from the epoxysilanes of formula (I):
RₙYₘSi(X)₄₋ₙ₋ₘ (I)
where:
R denotes a monovalent organic group bonded to the silicon via a carbon atom and containing at least one epoxy function,
X denotes a hydrolyzable group, preferably an —OR₁ group where R₁ denotes a linear or branched, preferably C₁-C₄, alkyl group, an alkoxyalkyl or acyloxy group, a halogen atom or an amino group optionally substituted with one or two alkyl or silane groups, preferably X denotes an alkoxy group,
Y denotes a monovalent organic group bonded to the silicon via a carbon atom and not containing an epoxy function, such as a saturated or unsaturated, C₁-C₁₀, and better still C₁-C₄, hydrocarbon-based group, in particular an alkyl group, and
n and m are integers such that: n=1 or 2 with n+m=1 or 2.

6. The abrasion-resistant film according to claim 5, wherein the epoxysilanes of the upper layer composition and of the lower layer composition are independently chosen from the epoxysilanes of formula RSi(X)₃, such as γ-glycidoxypropyltriethoxysilane, γ-glycidoxypropyltrimethoxysilane, 2-(3,4-epoxycyclohexyl)ethyltrimethoxysilane and 2-(3,4-epoxycyclohexyl)ethyltriethoxysilane, preferably γ-glycidoxypropyltrimethoxysilane (GLYMO).

7. The abrasion-resistant film according to claim 1, wherein the alkoxysilanes of the upper layer composition and of the lower layer composition are independently chosen from those of formula (II):
Si(OR′)₄ (II)
in which the R′ groups are identical to or different from one another and denote linear C₁-C₆ or branched C₃-C₆ alkyl groups.

8. The abrasion-resistant film according to claim 7, wherein the alkoxysilanes of the upper layer composition and of the lower layer composition are independently chosen from tetraalkyl orthosilicates, such as tetraethoxysilane (or TEOS), tetramethoxysilane or TMOS), tetra(n-propoxy)silane, tetra(isopropoxy)silane, tetra(n-butoxy)silane, tetra(sec-butoxy)silane and tetra(t-butoxy)silane, preferably tetraethoxysilane (TEOS).

9. The abrasion-resistant film according to claim 1, wherein Rl is at least equal to 3.5, preferably at least equal to 4 or even at least equal to 4.5.

10. The abrasion-resistant film according to claim 1, wherein Ru is less than 1.5, preferably less than 1.

11. The abrasion-resistant film according to claim 1, which also contains a layer of adhesive applied on the face of the transparent film opposite that bearing the abrasion-resistant coating.

12. An optical article, in particular ophthalmic lens, comprising:
a transparent substrate made of organic glass,
an adhesive layer covering at least one of the faces of the transparent substrate, and
an abrasion-resistant film as defined in claim 1.

13. The optical article according to claim 12, which is an ophthalmic lens in which the two faces of the substrate are covered with an abrasion-resistant film.

14. The optical article according to claim 12, which has a minimum thickness at the center of less than 2 mm, preferably less than 1.5 mm, even more preferably less than 1.2 mm.

15. A process for manufacturing an optical article according to claim 12, comprising:
providing a transparent organic substrate, preferably an ophthalmic lens substrate,
providing at least one abrasion-resistant film according to claim 11,
bringing the layer of adhesive of the abrasion-resistant film into contact with the organic substrate, and
applying a uniform pressure over the entire contact zone so as to cause the abrasion-resistant film to adhere on the organic substrate.

16. A process for manufacturing an optical article according to claim 12, comprising:
providing a transparent organic substrate, preferably an ophthalmic lens substrate, covered on at least one of its faces with a layer of adhesive,
providing at least one abrasion-resistant film according to claim 1,
bringing the face of the abrasion-resistant film bearing the transparent film into contact with the layer of adhesive, and
applying a uniform pressure over the entire contact zone so as to cause the abrasion-resistant film to adhere on the organic substrate.
